(19) United States
(12) Patent Application Publication
(10) Pub. No.: US 2026/0291148 A1
(43) Pub. Date: Sep. 24, 2026

(54) Electrical Connector Structure

(71) Applicant: Dongguan YUQIU Electronic Co., Ltd., Dongguan (CN)

(72) Inventors: JI GAO QIAN,, Dongguan (CN); XIN QIAN, Dongguan (CN); Ke HUI Li, Dongguan (CN)

(21) Appl. No.: 19/240,073

(22) Filed: Jun. 17, 2025

(30) Foreign Application Priority Data
Mar. 19, 2025 (TW) 114110373

(51) Int. Cl. H01R 13/6596; H01R 13/506; H01R 13/66; H01R 13/717

(52) U.S. Cl. CPC H01R 13/6596; H01R 13/506; H01R 13/6633; H01R 13/6658; H01R 13/7172

(57) ABSTRACT

The invention discloses an electrical connector structure including an insulation base, a signal terminal set, a grounding terminal set, two light-emitting members, a light-guiding member, an insulation housing, a metal case, a control circuit board, a signal connecting member and a transformer module. The signal terminal set, the grounding terminal set and the two light-emitting members are respectively arranged on the insulation base. The light-guiding member is arranged on the top of the two light-emitting members, and the insulation housing covers the insulation base, the two light-emitting members and the light-guiding member therein. The control circuit board is electrically connected to the signal terminal set, the grounding terminal set, the signal connecting member and the transformer module. Finally, the above-mentioned elements are respectively covered by the metal case. The first to eighth signal solder pins of the signal terminal set and the five ground solder pins of the grounding terminal set are arranged alternately in the same direction and on the same axis.

### BACKGROUND OF THE INVENTION

### Field of the Invention

The invention relates to a technical field of electrical connector, and more particularly to an electrical connector configured to mate with a plug of RJ45 connected to a cable.

### Description of the Related Art

Conventional RJ (Registered Jack) electrical connectors mainly include two kinds, the RJ11 connectors and the RJ45 connectors. The RJ45 connectors have a size greater than that of the RJ11 connectors, and each of the RJ45 connectors has eight terminals for requirements in computer network and digital communication.

As the technology of communication develops, demands for the data transmission speed and the bandwidth for communication are continuously increased, for example the data transmission speed is increased from 155 Mbps to 1 Gbps, 2.5 Gbps or even 10 Gbps, However, the higher data transmission speed the conventional RJ45 connectors provide, more electromagnetic waves are generated by the eight contact terminals, whereby the signals transmitted in the eight terminals are interfered by the electromagnetic waves.

Moreover, the conventional RJ45 connectors have eight terminals arranged in a separated manner, i.e. not in the same axis, which causes a more complicated soldering process for the connectors.

Therefore, it is an important issue for the conventional RJ45 connectors to reduce electromagnetic interference and simplify the soldering process.

### BRIEF SUMMARY OF THE INVENTION

The invention provides an electrical connector structure. The electrical connector structure in accordance with an exemplary embodiment of the invention is configured to mate with a plug of RJ45 connected to a cable. The electrical connector structure of the embodiment includes an insulation base, a signal terminal set, a grounding terminal set, at least two light emitting members, a light guiding member, an insulation housing, a metal case, a control circuit board, a signal connecting member and a transformer module.

The insulation base includes a base portion and a plate portion extending from a lateral side of the base portion; the signal terminal set is disposed in the insulation base and includes a first signal terminal, a second signal terminal, a third signal terminal, a fourth signal terminal, a fifth signal terminal, a sixth signal terminal, a seventh signal terminal, and an eighth signal terminal; the grounding terminal set is disposed in the insulation base and includes at least five grounding solder pins and a grounding substrate connected to the grounding solder pins, wherein the grounding substrate corresponds to a middle portion of the first signal terminal, the second signal terminal, the third signal terminal, the fourth signal terminal, the fifth signal terminal, the sixth signal terminal, the seventh signal terminal, and the eighth signal terminal respectively; the at least two light emitting members are disposed on a left end and a right end of the base portion; the light guiding member includes two light guiding columns disposed above a top portion of the light emitting members respectively; the insulation housing is provided with an insertion space, wherein the insulation housing encloses the insulation housing, the light emitting members, the light guiding columns and the plate portion are located in the insertion space, and a front end of the light guiding columns is uncovered by the insulation housing; the metal case includes a metal baffle movably joined to a bottom thereof; the control circuit board includes a first solder pin set, a second solder pin set and a third solder pin set disposed on a surface thereof; the signal connecting member configured to electrically connect the control circuit board and a predetermined electronic device, wherein the signal connecting member includes a first signal connecting terminal set; a transformer module electrically connected to the control circuit board, wherein the transformer module includes a primary side terminal set and a secondary side terminal set.

The first signal terminal is provided with a first signal solder pin and a first contact portion opposite to the first signal solder pin, the second signal terminal is provided with a second signal solder pin and a second contact portion opposite to the second signal solder pin, the third signal terminal is provided with a third signal solder pin and a third contact portion opposite to the third signal solder pin, the fourth signal terminal is provided with a fourth signal solder pin and a fourth contact portion opposite to the fourth signal solder pin, the fifth signal terminal is provided with a fifth signal solder pin and a fifth contact portion opposite to the fifth signal solder pin, the sixth signal terminal is provided with a sixth signal solder pin and a sixth contact portion opposite to the sixth signal solder pin, the seventh signal terminal is provided with a seventh signal solder pin and a seventh contact portion opposite to the seventh signal solder pin, and the eighth signal terminal is provided with an eighth signal solder pin and an eighth contact portion opposite to the eighth signal solder pin.

The base portion of the insulation base and the signal connecting member are joined to two ends of the control circuit board respectively, whereby the first solder pin set is electrical connected to the first signal solder pin, the second signal solder pin, the third signal solder pin, the fourth signal solder pin, the fifth signal solder pin, the sixth signal solder pin, the seventh signal solder pin, the eighth signal solder pin of the signal terminal set and the five grounding solder pins of the grounding terminal set, the first signal connecting terminal set of the signal connecting member is electrically connected to the third solder pin set, and the primary side terminal set and the secondary side terminal set are electrically connected to the second solder pin set. The metal case and metal baffle enclose the control circuit board, the signal connecting member and the transformer module.

Therefore, as the signal solder pins and the grounding solder pins are arranged in the same axis, the soldering process for the terminals is simplified, and the time required in the soldering process is thus reduced.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an electrical connector structure of the invention;

FIG. 2 is a partially exploded view of the electrical connector structure of FIG. 1;

FIG. 3 is a partially exploded view of a portion of the electrical connector structure of FIG. 2;

FIG. 4 is an exploded view of the electrical connector structure of FIG. 3 at another view angle;

FIG. 5 is another partially exploded view of the electrical connector structure of FIG. 1;

FIG. 6 is a perspective view of a signal terminal set and a grounding terminal set of the electrical connector structure of the invention;

FIG. 7 is a perspective view of a signal terminal set and a grounding terminal set of the electrical connector structure of the invention at another view angle;

FIG. 8 is a perspective view of the electrical connector structure of FIG. 1 with removal of an insulation housing, a metal case, a control circuit board, a signal connecting member and a transformer module;

FIG. 9 is a partially exploded view of FIG. 8;

FIG. 10 is a perspective view of an insulation housing of the electrical connector structure of FIG. 1;

FIG. 11 is a perspective view of the insulation housing of FIG. 10 at another view angle;

FIG. 12 is a perspective view of an assembly of the portion of the electrical connector structure shown in FIG. 8 and the insulation housing;

FIG. 13 is a perspective view of the metal case of the electrical connector structure of FIG. 1; and

FIG. 14 is a perspective view of an assembly of the portion of the electrical connector structure shown in FIG. 12 and the metal case.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

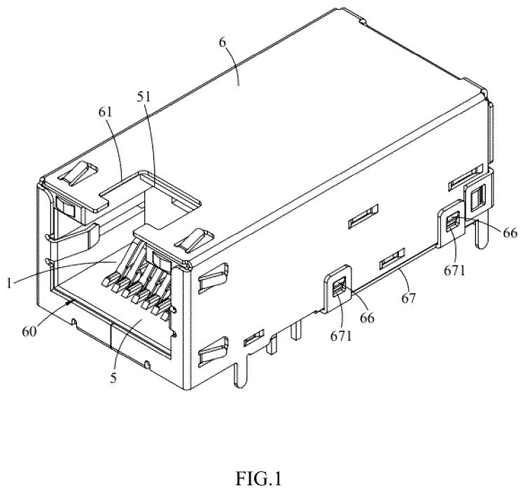

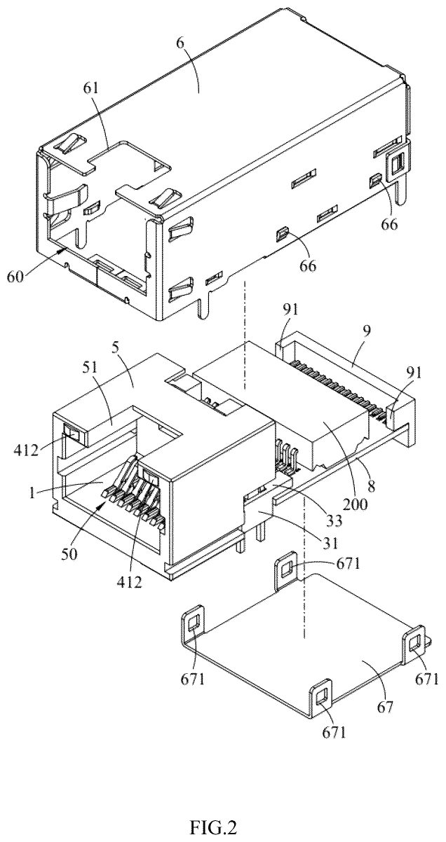

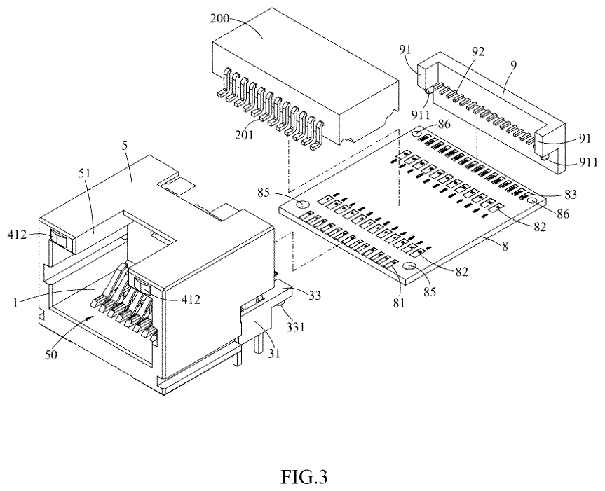

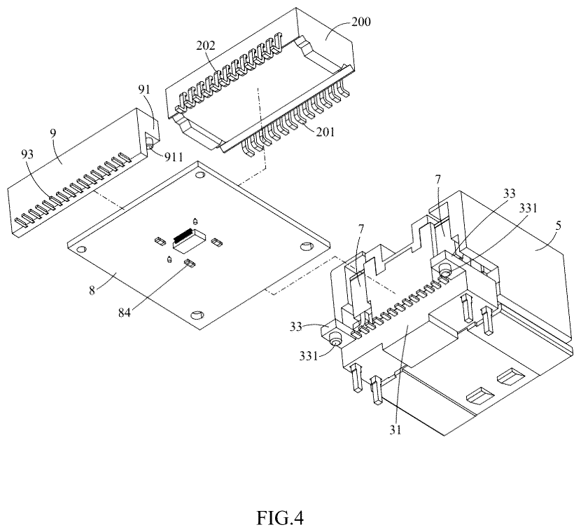

Referring to FIGS. 1, 2, 3 and 4, the present invention discloses an electrical connector structure configured to mate with an RJ 45 plug having an elastic fastening member on a top portion thereof. The electrical connector structure 100 of the embodiment includes an insulation base 3, a signal terminal set 1, a grounding terminal set 2, at least two light emitting members 7, a light guiding member 4, an insulation housing 5, a metal case 6, a control circuit board 8, a signal connecting member 9 and a transformer module 200.

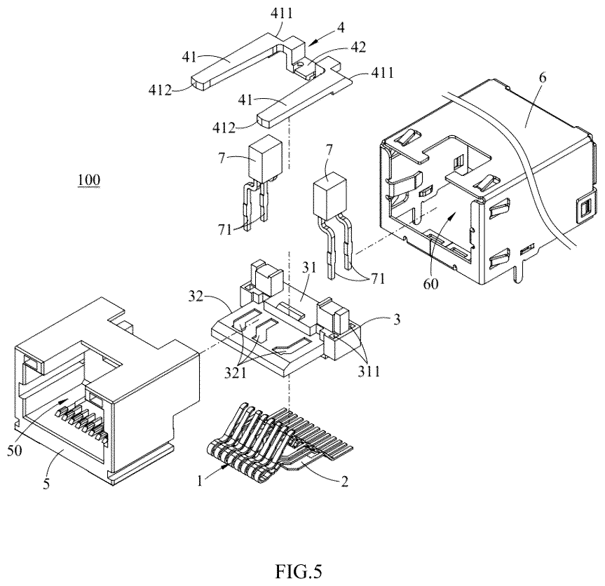

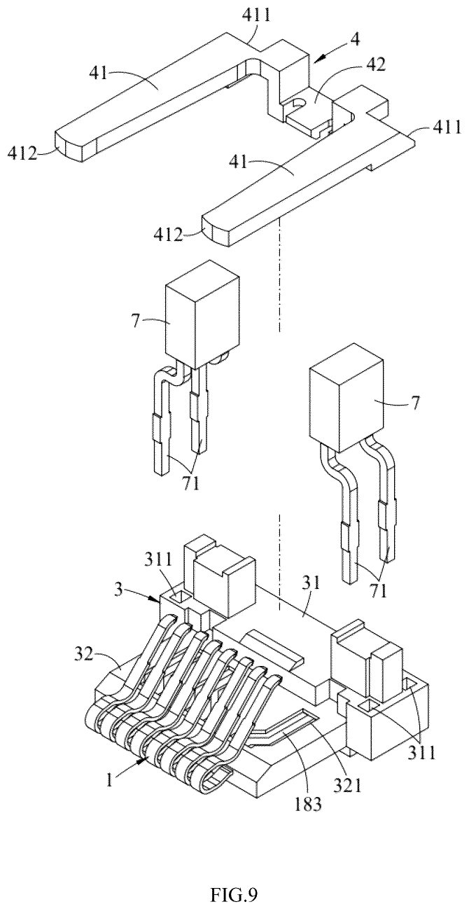

The insulation base 3 (also referring to FIGS. 5, 8 and 9) includes a base portion 31 and a plate portion 32 extending from a lateral side of the base portion 31. The base portion 31 has two positioning holes 311 at a left end and a right end thereof respectively. The plate portion 32 includes a plurality of openings 321 formed on a top portion and a bottom portion thereof. The insulation base 3 further includes two first connecting portions 33 extending from two ends of a back of the base portion 31 respectively and two first positioning posts 331 disposed on a bottom of each of the first connecting portions 33 respectively.

The signal terminal set 1 (also referring to FIGS. 5, 8 and 9) is disposed in the insulation base 3 and includes a first signal terminal 11, a second signal terminal 12, a third signal terminal 13, a fourth signal terminal 14, a fifth signal terminal 15, a sixth signal terminal 16, a seventh signal terminal 17, and an eighth signal terminal 18.

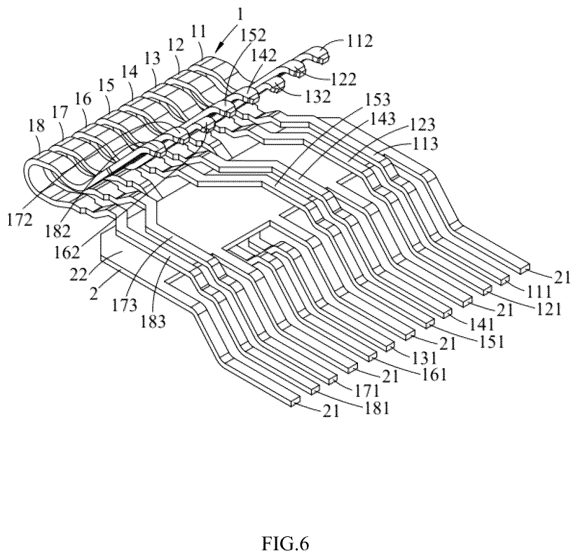

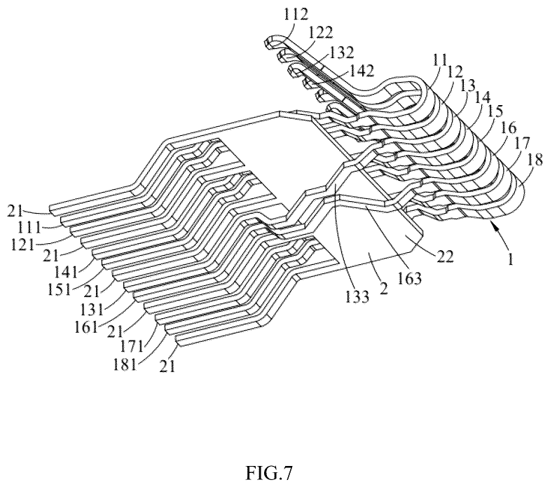

The grounding terminal set 2 (also referring to FIGS. 5, 6 and 7) is disposed in the insulation base 3 and includes at least five grounding solder pins 21 and a grounding substrate 22 connected to the grounding solder pins 21. The grounding substrate 22 corresponds to a middle portion of the first signal terminal 11, the second signal terminal 12, the third signal terminal 13, the fourth signal terminal 14, the fifth signal terminal 15, the sixth signal terminal 16, the seventh signal terminal 17, and the eighth signal terminal 18 respectively (as shown in FIGS. 6 and 7).

Each of the light emitting members 7 (also referring to FIGS. 5, 8 and 9) includes two connecting terminals 71 inserted into the positioning holes 311, whereby the light emitting members 7 are disposed on a left end and a right end of the base portion 31.

The light guiding member 4 (also referring to FIGS. 5, 8 and 9) includes two light guiding columns 41 disposed above a top portion of the light emitting members 7 respectively. The light guiding member 4 further includes a connection section 42 connecting the light guiding columns 41. The light guiding column 41 includes an inclined surface 411 at one end and a curved surface 412 at another end. The inclined surface 411 is located above the top portion of the light emitting members 7, and the light guiding column 41 has a width gradually decreased from the end having the inclined surface 411 to the end having the curved surface 412.

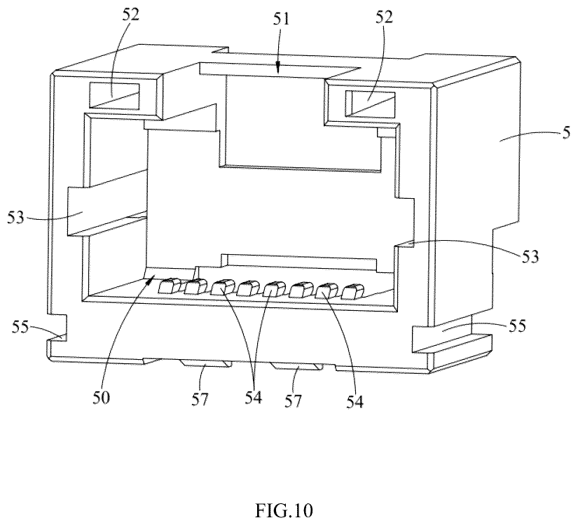

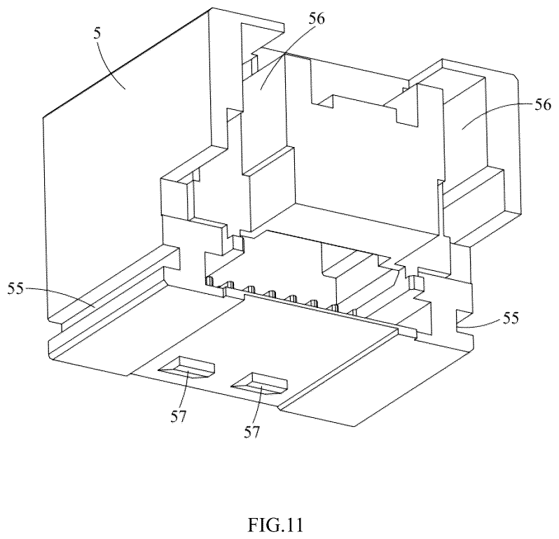

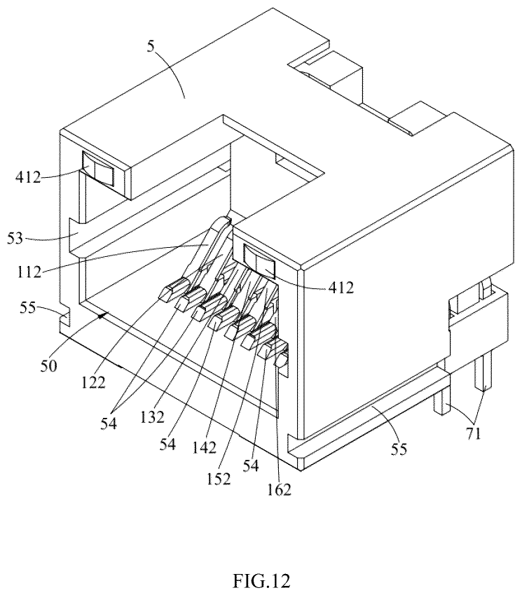

The insulation housing 5 (also referring to FIGS. 5, 10, 11 and 12) is provided with an insertion space 50. The insulation housing 5 includes a first opening 51 above the insertion space 50 and two first accommodating grooves 52 disposed at two opposite sides of the first opening 51. The insulation housing 5 includes two depressed grooves 53 disposed on two opposite inner walls forming the insertion space 50, at least eight positioning grooves 54 formed at a bottom of the insertion space 50, two limiting grooves 55 formed on two opposite outer walls thereof, two second accommodating grooves 56 formed on an external back portion thereof, two securing protrusions 57 disposed on an outer bottom surface thereof. The insulation housing 5 encloses the insulation base 3, the light emitting members 7 and the light guiding columns 41. The plate portion 32 of the insulation base 3 are located in the insertion space 50. The light guiding columns 41 are disposed in the first accommodating grooves 52 respectively, and the light emitting members 7 are disposed in the second accommodating grooves 56 respectively. The curved surface 412 of the light guiding column 41 is exposed from the insulation housing 5 (as shown in FIG. 12).

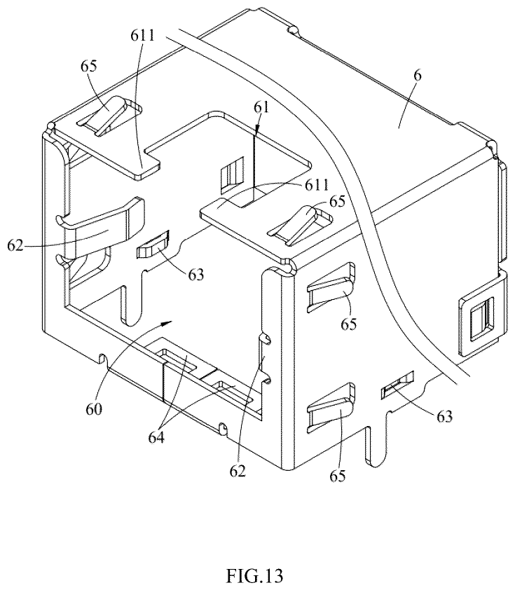

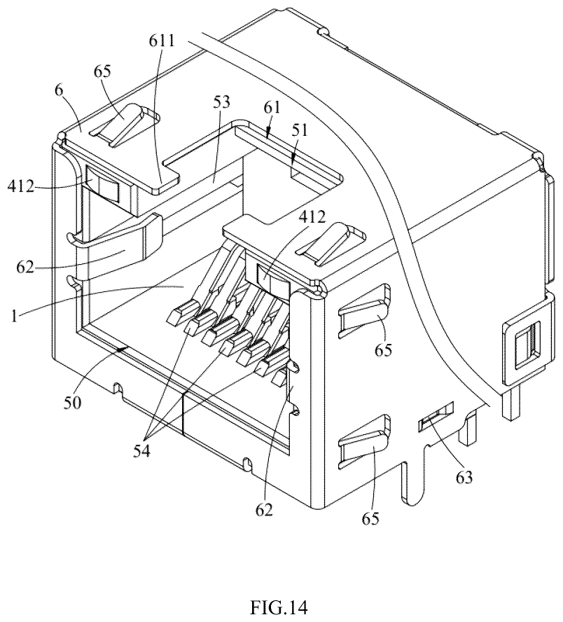

The metal case 6 (also referring to FIGS. 5, 13 and 14) includes metal baffle 67 movably joined to a bottom thereof. The metal case 6 further includes an insertion port 60 corresponding to an opening of the insertion space 50 of the insulation housing 5, a second opening 61 corresponding to the first opening 51 of the insulation housing 5, and two blocking portions 611 separately disposed in a front edge of the second opening 61. The elastic fastener disposed on the RJ45 plug is configured to be positioned in the first opening 51 and the second opening 61. The metal case 6 further includes two first shielding spring sheets 62 disposed at two opposite sides of the insertion port 61 and bending inwards, two limiting protrusions 63 disposed on opposite outer walls thereof, two securing fasteners 64 disposed at a bottom thereof, and a plurality of second shielding spring sheets 65 disposed on the outer wall and a top surface thereof. The metal case 6 encloses the insulation housing 5. The first shielding spring sheets 62 of the metal case 6 are located in the depressed grooves 53 of the insulation housing 5, the limiting protrusions 63 of the metal case 6 are located in the limiting grooves 55 of the insulation housing 5, whereby the metal case 6 is firmly joined to the insulation housing 5. The securing fasteners 64 of the metal case 6 engage with the securing protrusions 57 the insulation housing 5, whereby the metal case 6 is more firmly joined to the insulation housing 5. Moreover, the metal case 6 further includes a plurality of first joining portions 66 disposed on an outer wall thereof and a plurality of second joining portions 671 disposed on the metal baffle 67, and the first joining portions 66 engage with the second joining portions 671, whereby the metal baffle 67 is movably joined to the bottom of the metal case 6.

The control circuit board 8 includes a first solder pin set 81, a second solder pin set 82 and a third solder pin set 83 disposed on a surface thereof. The control circuit board 8 further includes a plurality of electronic control elements 84 disposed on another surface thereof. The control circuit board 8 includes at least two first positioning holes 85 adjacent to the first solder pin set 81 and at least two second positioning holes 86 adjacent to the third solder pin set 83.

The signal connecting member 9 is configured to electrically connect the control circuit board 8 and a predetermined electronic device. The signal connecting member 9 includes a first signal connecting terminal set 92 at one end and a second signal connecting terminal set 93 at the other end. The signal connecting member 9 further includes two second connecting portions 91 extending from two sides thereof and two second positioning posts 911 disposed on a bottom of each of the second connecting portions 91 respectively.

The transformer module 200 is electrically connected to the control circuit board 8. The transformer module 200 includes a primary side terminal set 201 disposed in one side and a secondary side terminal set 202 in another side.

The base portion 31 of the insulation base 3 and the signal connecting member 9 are joined to two ends of the control circuit board 8 respectively, and the first positioning posts 331 disposed on a bottom of each of the first connecting portions 33 are joined to the first positioning holes 85 of the control circuit board 8, whereby the first solder pin set 81 is electrical connected to the first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181 of the signal terminal set 1 and the five grounding solder pins 21 of the grounding terminal set 2. The second positioning posts 911 disposed on the second connecting portions 91 are joined to the second positioning holes 86 of the control circuit board 8, whereby the signal connecting member 9 is firmly joined to the control circuit board 8 and the first signal connecting terminal set 92 of the signal connecting member 9 is electrically connected to the third solder pin set 83. Moreover, the primary side terminal set 201 and the secondary side terminal set 202 of the transformer module 200 are electrically connected to the second solder pin set 82. Therefore, electrical connection is constructed among the signal terminal set 1, the grounding terminal set 2, the transformer module 200 and the signal connecting member 9.

The second signal connecting terminal set 93 of the signal connecting member 9 is configured to electrically connected to a predetermined external electronic device.

The metal case 6 encloses the insulation housing 5, the control circuit board 8, the signal connecting member 9 and the transformer module 200, and the metal baffle is joined to the bottom of the metal case 6 to completely cover the control circuit board 8. In addition, the first shielding spring sheets 62 of the metal case 6 are located in the depressed grooves 53 of the insulation housing 5, the limiting protrusions 63 of the metal case 6 are located in the limiting grooves 55 of the insulation housing 5, whereby the metal case 6 is firmly joined to the insulation housing 5. The securing fasteners 64 of the metal case 6 engage with the securing protrusions 57 the insulation housing 5, whereby the metal case 6 is more firmly joined to the insulation housing 5.

The arrangement and functions of the first solder pin set 81, the second solder pin set 82 and the third solder pin set 83 of the control circuit board 8 are described as follows. The first solder pin set 81 is electrically connected to the first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181 of the signal terminal set 1 and the five grounding solder pins 21 of the grounding terminal set 2. The first solder pin set 81 includes thirteen pins arranged in a sequence of a first grounding pin, a first signal pin, a second signal pin, a second grounding pin, a fourth signal pin, a fifth signal pin, s third grounding pin, a third signal pin, a sixth signal pin, a fourth grounding pin, a seventh signal pin, an eighth signal pin, and a fifth grounding pin.

The second solder pin set 82 includes twenty-four pins, and the primary side terminal set 201 and the secondary side terminal set 202 of the transformer module 200 are electrically connected to the second solder pin set 82. The first pin to the twelfth pins (the primary pins) of the second solder pin set 82 are arranged in a sequence of a first tapped grounding pin, a first positive data pin, a first negative data pin, a second tapped grounding pin, a second positive data pin, a second negative data pin, a third tapped grounding pin, a third positive data pin, a third negative data pin, a fourth tapped grounding pin, a fourth positive data pin, and a fourth negative data pin. The thirteenth pin to the twenty-fourth pin (the secondary pins) of the second solder pin set 82 are arranged in a sequence of a fourth negative differential signal pin, a fourth positive differential signal pin, a fourth tapped grounding pin, a third negative differential signal pin, a third positive differential signal pin, a third tapped grounding pin, a second negative differential signal pin, a second positive differential signal pin, a second tapped grounding pin, a first negative differential signal pin, a first positive differential signal pin, and a first tapped grounding pin.

The third solder pin set 83 includes sixteen solder pins and electrically connected to the first signal connecting terminal set 92 of the signal connecting member 9. The sixteen solder pins of the third solder pin set 83 are arranged in a sequence of a first power pin, a first tapped grounding pin, a first positive differential signal pin, a first negative differential signal pin, a second power pin, a second tapped grounding pin, a second positive differential signal pin, a second negative differential signal pin, a third power pin, a third tapped grounding pin, a third positive differential signal pin, a third negative differential signal pin, a fourth power pin, a fourth tapped grounding pin, a fourth positive differential signal pin, and a fourth negative differential signal pin.

The structures of the signal terminal set 1 and the grounding terminal set 2 are described as follows. The first signal terminal 11 is provided with a first signal solder pin 111, a first contact portion 112 opposite to the first signal solder pin 111 and a first signal section 113 between the first contact portion 112 and the first signal solder pin 111. The second signal terminal 12 is provided with a second signal solder pin 121, a second contact portion 122 opposite to the second signal solder pin 121 and a second signal section 123 between the second contact portion 122 and the second signal solder pin 121. The third signal terminal 13 is provided with a third signal solder pin 131, a third contact portion 132 opposite to the third signal solder pin 131 and a third signal section 133 between the third contact portion 132 and the third signal solder pin 131. The fourth signal terminal 14 is provided with a fourth signal solder pin 141, a fourth contact portion 142 opposite to the fourth signal solder pin 141 and a fourth signal section 143 between the fourth contact portion 142 and the fourth signal solder pin 141. The fifth signal terminal 15 is provided with a fifth signal solder pin 151, a fifth contact portion 152 opposite to the fifth signal solder pin 151 and a fifth signal section 153 between the fifth contact portion 152 and the fifth signal solder pin 151. The sixth signal terminal 16 is provided with a sixth signal solder pin 161, a sixth contact portion 162 opposite to the sixth signal solder pin 161 and a sixth signal section 163 between the sixth contact portion 162 and the sixth signal solder pin 161. The seventh signal terminal 17 is provided with a seventh signal solder pin 171, a seventh contact portion 172 opposite to the seventh signal solder pin 171 and a seventh signal section 173 between the seventh contact portion 172 and the seventh signal solder pin 171. The eighth signal terminal 18 is provided with an eighth signal solder pin 181, an eighth contact portion 182 opposite to the eighth signal solder pin 181 and an eighth signal section 183 between the eighth contact portion 182 and the eighth signal solder pin 181.

The first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, and the five grounding solder pins 21 are arranged along an identical direction in a sequence of one of the grounding solder pins 21, the first signal solder pin 111, the second signal solder pin 121, one of the grounding solder pins 21, the fourth signal solder pin 141, the fifth signal solder pin 151, one of the grounding solder pins 21, the third signal solder pin 131, the sixth signal solder pin 161, one of the grounding solder pins 21, the seventh signal solder pin 171, the eighth signal solder pin 181, and one of the grounding solder pins 21.

Therefore, two grounding solder pins 21 are disposed on a left side of the first signal solder pin 111 and on a right side of the eighth signal solder pin 181 to provide shielding against electromagnetic interference. The other three grounding solder pins 21 are disposed between every two signal solder pins to provide shielding against electromagnetic interference. In this way, the first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, and the five grounding solder pins 21 are alternately arranged to reduce or even cease the electromagnetic interference between the first signal terminal 11, the second signal terminal 12, the third signal terminal 13, the fourth signal terminal 14, the fifth signal terminal 15, the sixth signal terminal 16, the seventh signal terminal 17 and the eighth signal terminal 18.

The grounding substrate 22 of the grounding terminal set 2 corresponds to a middle portion of the first signal terminal 11, the second signal terminal 12, the third signal terminal 13, the fourth signal terminal 14, the fifth signal terminal 15, the sixth signal terminal 16, the seventh signal terminal 17, and the eighth signal terminal 18 respectively. That is the grounding substrate 22 is located in a position corresponding to the first signal section 113, the second signal section 123, the third signal section 133, the fourth signal section 143, the fifth signal section 153, the sixth signal section 163, the seventh signal section 173, and the eighth signal section 183, whereby the first signal section 113, the second signal section 123, the fourth signal section 143, the fifth signal section 153, the seventh signal section 173, and the eighth signal section 183 are positioned above the grounding substrate 22, and the third signal section 133 and the sixth signal section 163 are positioned under the grounding substrate 22.

The first contact portion 112, the second contact portion 122, the third contact portion 132, the fourth contact portion 142, the fifth contact portion 152, the sixth contact portion 162, the seventh contact portion 172 and the eighth contact portion 182 are arranged in a row along an identical direction. The arrangement is as the following sequence: the first contact portion 112, the second contact portion 122, the third contact portion 132, the fourth contact portion 142, the fifth contact portion 152, the sixth contact portion 162, the seventh contact portion 172 and the eighth contact portion 182.

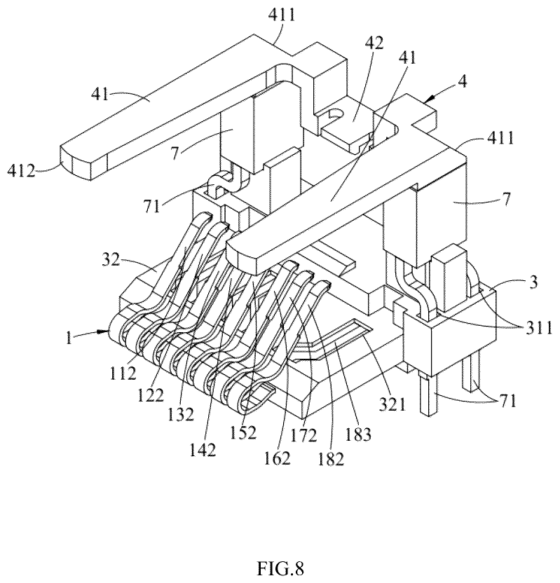

The first contact portion 112, the second contact portion 122, the third contact portion 132, the fourth contact portion 142, the fifth contact portion 152, the sixth contact portion 162, the seventh contact portion 172 and the eighth contact portion 182 extend beyond a front end of the plate portion 32 of the insulation base 3 and correspond to eight positioning grooves 54, whereby the first contact portion 112, the second contact portion 122, the third contact portion 132, the fourth contact portion 142, the fifth contact portion 152, the sixth contact portion 162, the seventh contact portion 172 and the eighth contact portion 182 extend into the insertion space 50 (as shown in FIGS. 5 and 8). The first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, and the five grounding solder pins 21 are exposed from the insulation base 3.

The plate portion 32 includes the plurality of openings 321 on the top and the bottom corresponding to the first signal section 113, the second signal section 123, the third signal section 133, the fourth signal section 143, the fifth signal section 153, the sixth signal section 163, the seventh signal section 173, and the eighth signal section 183 (as shown in FIGS. 1, 4 and 5), thereby exposing the first signal section 113, the second signal section 123, the third signal section 133, the fourth signal section 143, the fifth signal section 153, the sixth signal section 163, the seventh signal section 173, and the eighth signal section 183 to increase impedance of the signal terminal set 1.

As aforementioned, the first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, and the five grounding solder pins 21 are alternately arranged to reduce or even cease the electromagnetic interference between the first signal terminal 11, the second signal terminal 12, the third signal terminal 13, the fourth signal terminal 14, the fifth signal terminal 15, the sixth signal terminal 16, the seventh signal terminal 17 and the eighth signal terminal 18.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrical connector structure configured to mate with an RJ 45 plug having an elastic fastening member on a top portion thereof, comprising:
a control circuit board comprises a first solder pin set, a second solder pin set and a third solder pin set disposed on a surface thereof, wherein the third solder pin set comprises sixteen solder pins arranged in a sequence of a first power pin, a first tapped grounding pin, a first positive differential signal pin, a first negative differential signal pin, a second power pin, a second tapped grounding pin, a second positive differential signal pin, a second negative differential signal pin, a third power pin, a third tapped grounding pin, a third positive differential signal pin, a third negative differential signal pin, a fourth power pin, a fourth tapped grounding pin, a fourth positive differential signal pin, and a fourth negative differential signal pin;
a signal connecting member configured to electrically connect the control circuit board and a predetermined electronic device, wherein the signal connecting member comprises a first signal connecting terminal set, the signal connecting member is joined to one end of the control circuit board, and the first signal connecting terminal set is electrically connected to the third solder pin set respectively;
a transformer module electrically connected to the control circuit board, wherein the transformer module comprises a primary side terminal set and a secondary side terminal set, the primary side terminal set and the secondary side terminal set;
an insulation base comprising a base portion and a plate portion extending from a lateral side of the base portion, wherein another lateral side of the base portion is joined to another end of the control circuit board;
a signal terminal set disposed in the insulation base and comprising a first signal terminal, a second signal terminal, a third signal terminal, a fourth signal terminal, a fifth signal terminal, a sixth signal terminal, a seventh signal terminal, and an eighth signal terminal;
a grounding terminal set disposed in the insulation base and comprising at least five grounding solder pins and a grounding substrate connected to the grounding solder pins, wherein the grounding substrate corresponds to a middle portion of the first signal terminal, the second signal terminal, the third signal terminal, the fourth signal terminal, the fifth signal terminal, the sixth signal terminal, the seventh signal terminal, and the eighth signal terminal respectively;
at least two light emitting members disposed on a left end and a right end of the base portion;
a light guiding member comprising two light guiding columns disposed above a top portion of the light emitting members respectively;
an insulation housing provided with an insertion space, wherein the insulation housing encloses the insulation base, the light emitting members, the light guiding columns and the plate portion are located in the insertion space, and a front end of the light guiding columns is uncovered by the insulation housing; and
a metal case comprising a metal baffle movably joined to a bottom thereof;
wherein the first signal terminal is provided with a first signal solder pin and a first contact portion opposite to the first signal solder pin, the second signal terminal is provided with a second signal solder pin and a second contact portion opposite to the second signal solder pin, the third signal terminal is provided with a third signal solder pin and a third contact portion opposite to the third signal solder pin, the fourth signal terminal is provided with a fourth signal solder pin and a fourth contact portion opposite to the fourth signal solder pin, the fifth signal terminal is provided with a fifth signal solder pin and a fifth contact portion opposite to the fifth signal solder pin, the sixth signal terminal is provided with a sixth signal solder pin and a sixth contact portion opposite to the sixth signal solder pin, the seventh signal terminal is provided with a seventh signal solder pin and a seventh contact portion opposite to the seventh signal solder pin, and the eighth signal terminal is provided with an eighth signal solder pin and an eighth contact portion opposite to the eighth signal solder pin;
wherein the first contact portion, the second contact portion, the third contact portion, the fourth contact portion, the fifth contact portion, the sixth contact portion, the seventh contact portion and the eighth contact portion extend beyond a front end of the plate portion and into the insertion space, and the first signal solder pin, the second signal solder pin, the third signal solder pin, the fourth signal solder pin, the fifth signal solder pin, the sixth signal solder pin, the seventh signal solder pin, the eighth signal solder pin, and the grounding solder pins are alternately arranged along an identical direction;
wherein the first solder pin set is electrical connected to the first signal solder pin, the second signal solder pin, the third signal solder pin, the fourth signal solder pin, the fifth signal solder pin, the sixth signal solder pin, the seventh signal solder pin, the eighth signal solder pin of the signal terminal set and the five grounding solder pins of the grounding terminal set;
wherein the metal case and the metal baffle enclose the control circuit board, the signal connecting member and the transformer module.

2. The electrical connector structure as claimed in claim 1, wherein the light guiding column comprises an inclined surface at one end and a curved surface at another end, the inclined surface is located above the top portion of the light emitting members, and the light guiding column has a width gradually decreased from the end having the inclined surface to the end having the curved surface.

3. The electrical connector structure as claimed in claim 1, wherein the insulation housing comprises a first opening above the insertion space and two first accommodating grooves disposed at two opposite sides of the first opening, the light guiding columns are disposed in the first accommodating grooves respectively.

4. The electrical connector structure as claimed in claim 1, wherein the insulation housing comprises at least two second accommodating grooves formed on an external back portion thereof, and the light emitting members are disposed in the second accommodating grooves respectively.

5. The electrical connector structure as claimed in claim 1, wherein the insulation housing comprises two depressed grooves disposed on two opposite inner walls forming the insertion space, at least eight positioning grooves formed at a bottom of the insertion space, two limiting grooves formed on two opposite outer walls thereof, and two securing protrusions disposed on an outer bottom surface, and the first contact portion, the second contact portion, the third contact portion, the fourth contact portion, the fifth contact portion, the sixth contact portion, the seventh contact portion and the eighth contact portion correspond to the positioning grooves respectively.

6. The electrical connector structure as claimed in claim 3, wherein the metal case comprises an insertion port corresponding to an opening of the insertion space, a second opening corresponding to the first opening, and two blocking portions separately disposed in a front edge of the second opening.

7. The electrical connector structure as claimed in claim 5, wherein the metal case comprises an insertion port corresponding to an opening of the insertion space, two first shielding spring sheets disposed at two opposite sides of the insertion port and bending inwards, two limiting protrusions disposed on opposite outer walls thereof, two securing fasteners disposed at a bottom thereof, and a plurality of second shielding spring sheets disposed on the outer wall and a top surface thereof, wherein the first shielding spring sheets are located in the depressed grooves, the limiting protrusions are located in the limiting grooves, and the securing fasteners engage with the securing protrusions.

8. he electrical connector structure as claimed in claim 1, wherein the first signal terminal is further provided with a first signal section between the first contact portion and the first signal solder pin, the second signal terminal is further provided with a second signal section between the second contact portion and the second signal solder pin, the third signal terminal is further provided with a third signal section between the third contact portion and the third signal solder pin, the fourth signal terminal is further provided with a fourth signal section between the fourth contact portion and the fourth signal solder pin, the fifth signal terminal is further provided with a fifth signal section between the fifth contact portion and the fifth signal solder pin, the sixth signal terminal is further provided with a sixth signal section between the sixth contact portion and the sixth signal solder pin, the seventh signal terminal is further provided with a seventh signal section between the seventh contact portion and the seventh signal solder pin, and the eighth signal terminal is further provided with an eighth signal section between the eighth contact portion and the eighth signal solder pin; the grounding substrate corresponds to the first signal section, the second signal section, the third signal section, the fourth signal section, the fifth signal section, the sixth signal section, the seventh signal section, and the eighth signal section the first signal section, the second signal section, the fourth signal section, the fifth signal section, the seventh signal section, and the eighth signal section are positioned above the grounding substrate, and the third signal section and the sixth signal section are positioned under the grounding substrate.

9. The electrical connector structure as claimed in claim 1, wherein the first signal solder pin, the second signal solder pin, the third signal solder pin, the fourth signal solder pin, the fifth signal solder pin, the sixth signal solder pin, the seventh signal solder pin, the eighth signal solder pin, and the grounding solder pins are arranged along an identical direction in a sequence of one of the grounding solder pins, the first signal solder pin, the second signal solder pin, one of the grounding solder pins, the fourth signal solder pin, the fifth signal solder pin, one of the grounding solder pins, the third signal solder pin, the sixth signal solder pin, one of the grounding solder pins, the seventh signal solder pin, the eighth signal solder pin, and one of the grounding solder pins.

10. The electrical connector structure as claimed in claim 1, wherein the first contact portion, the second contact portion, the third contact portion, the fourth contact portion, the fifth contact portion, the sixth contact portion, the seventh contact portion and the eighth contact portion are arranged along an identical direction in a sequence of the first contact portion, the second contact portion, the third contact portion, the fourth signal solder pin, the fifth signal solder pin, the sixth signal solder pin, the seventh signal solder pin, and the eighth signal solder pin.

11. The electrical connector structure as claimed in claim 1, wherein the insulation base further comprises two first connecting portions extending from two ends of a back of the base portion respectively and two first positioning posts disposed on a bottom of each of the first connecting portions respectively, the signal connecting member further comprises two second connecting portions extending from two sides thereof and two second positioning posts disposed on a bottom of each of the second connecting portions respectively, the control circuit board comprises at least two first positioning holes adjacent to the first solder pin set and at least two second positioning holes adjacent to the third solder pin set, the first positioning posts are joined to the first positioning holes and the second positioning posts are joined to the second positioning holes.

12. The electrical connector structure as claimed in claim 1, wherein the signal connecting member further comprises a second signal connecting terminal set configured to electrically connected to a predetermined external electronic device.

13. The electrical connector structure as claimed in claim 1, wherein the metal case further comprises a plurality of first joining portions disposed on an outer wall thereof and a plurality of second joining portions disposed on the metal baffle, and the first joining portions engage with the second joining portions, whereby the metal baffle is movably joined to the bottom of the metal case.

14. The electrical connector structure as claimed in claim 1, wherein the control circuit board further comprises a plurality of electronic control elements disposed on another surface thereof.

15. The electrical connector structure as claimed in claim 1, wherein the first solder pin set comprises thirteen pins arranged in a sequence of a first grounding pin, a first signal pin, a second signal pin, a second grounding pin, a fourth signal pin, a fifth signal pin, s third grounding pin, a third signal pin, a sixth signal pin, a fourth grounding pin, a seventh signal pin, an eighth signal pin, and a fifth grounding pin.

16. The electrical connector structure as claimed in claim 1, wherein the second solder pin set comprises twenty-four pins, and twelve pins thereof are primary pins arranged in a sequence of a first tapped grounding pin, a first positive data pin, a first negative data pin, a second tapped grounding pin, a second positive data pin, a second negative data pin, a third tapped grounding pin, a third positive data pin, a third negative data pin, a fourth tapped grounding pin, a fourth positive data pin, and a fourth negative data pin.

17. The electrical connector structure as claimed in claim 1, wherein the second solder pin set comprises twenty-four pins, and twelve pins thereof are secondary pins arranged in a sequence of a fourth negative differential signal pin, a fourth positive differential signal pin, a fourth tapped grounding pin, a third negative differential signal pin, a third positive differential signal pin, a third tapped grounding pin, a second negative differential signal pin, a second positive differential signal pin, a second tapped grounding pin, a first negative differential signal pin, a first positive differential signal pin, and a first tapped grounding pin.
